(19) United States
(12) Patent Application Publication
(10) Pub. No.: US 2015/0347685 A1
(43) Pub. Date: Dec. 3, 2015

(54) METHOD AND A SYSTEM FOR SHARING AND ANALYSING UNSTRUCTURED HEALTHCARE DATA

(71) Applicants: Debasis Dutta, Pune (IN); Monika Sangra, Pune (IN)

(72) Inventors: Debasis Dutta, Pune (IN); Monika Sangra, Pune (IN)

(21) Appl. No.: 14/555,523

(22) Filed: Nov. 26, 2014

(30) Foreign Application Priority Data
Jun. 3, 2014 (IN) 1831/MUM/2014

(51) Int. Cl. G06F 19/00; H04L 29/06

(52) U.S. Cl. CPC G06F 19/322; H04L 63/1433; H04L 63/061

(57) ABSTRACT

The present invention provides a method and a system for securely sharing and analyzing the unstructured healthcare data of patients. Specifically, the method comprises steps of collecting healthcare data, encrypting the healthcare data, uploading the encrypted healthcare data, fetching encrypted healthcare data, providing selective access to the healthcare data and extending the secure view to other users. Further, the method has a step of reducing the secure view to other users as per the user scope and analyzing the patient's healthcare data. The healthcare date is analysed with respect to extracted features for generating trends and by building/executing query against external healthcare data source.

This application is based on and claims the benefit of priority from Indian Patent Application No: 1831/MUM/2014 filed Jun. 3, 2014, the contents of which are incorporated by reference.

### FIELD OF THE INVENTION

The present invention relates to healthcare data management, more particularly, the present invention relates to a method and a system for sharing and analyzing unstructured healthcare data in open system, which is accessed by more than one unrelated users.

### BACKGROUND OF THE INVENTION

At present health tracking and analysis has become more important and critical for every individual. Healthcare of an individual is impacted due to variation in lifestyle, stress due to external factors such as long working hours, not able to exercise regularly. Further, due to unawareness of health condition which is slowly degrading and unable to visit healthcare entities for health advices will aggravate the health problem and may cause severe damage to the health of the individual. Similarly, various healthcare entities also requires pattern related to diseases or health or lifestyle behaviour, so that probable cause of behaviour is known and effect of the behaviour can be determined which will reduce the time to propose effective solution to rectify the abnormal health/lifestyle behaviour proactively and help entities in healthcare domain to do business intelligence to reduce cost

As on day, there is a lack of method in which healthcare entities can collaborate for storing the health data securely and sharing by creating secure view which can be shared fully or by creating restricted view for sharing further and use the extracted feature of healthcare data without compromising owner identity for analysis, to help various entities to achieve the goal described above.

There are various electronic health record EHR systems available. But these EHR are more of a producer oriented system. These EHR systems may or may not be interactive between the doctor, patient and the test facilities. Further, the healthcare history of a user is not carried forward across health provider and there are no methods by which history can be stored securely in an open system and enable sharing of historical data securely. With-in the same health provider, health history is carried forward but not across health providers which means no previous health/lifestyle history available to a heath provider when a new user is registered to a different health provider. Further, the EHR system does not interact with external data sources such as tweeter; online maps etc. to provide the in-context general information which enrich the knowledge of patient and based on which patient will make take more concise decisions. The features which are extracted from the patient will be used to find the nearest doctors/hospitals/Medicines information/Medical equipments/Chemists etc.

These EHR systems are not equipped to capture real time unstructured data, which a user might want to capture as per his daily health behaviour and are lost when visited to doctor later point in time and then diagnosis can prolong increasing the treatment cost. The information that is collected is spread across the various providers' due to which the patient health holistic view and his behaviour pattern are not available in single pane. Specific/restricted view is available to a doctors which cannot be enriched as the data for enriching the view is not available and system to forward/share the data securely to heath care entities are not available hence method to predict the effect of the current abnormal state and suggest changes in lifestyle or precaution measure to proactively rectify the abnormalities is not available as an open secure system

Therefore, there is a need to provide a method and a system for securely storing and sharing on server. Further a system is needed to extract important feature from unstructured healthcare data for analysis on user's device before securing the data to be upload on server. A system to help individual/doctors/healthcare entities to share information securely so that doctors/practitioner can have complete and secure view to make an informed decision which helps in more accurate treatment. The method and the system will help doctors/practitioner/individuals that are located in remote places, enabling them to ask for an opinion from an expert doctor(s) by sharing health data securely which will eventually reduce the healthcare cost by connecting the healthcare entities. The method and the system will help healthcare entities by providing the trends related to heathcare data to enable them in decision making proactively. The method and system for authorization of the heath care data by the user who has uploaded it is needed in open system such that only the person who is an indented recipient of the data can view the data

### OBJECTS OF THE INVENTION

An object of the present invention is to provide a method and a system for securely sharing and securely analyzing unstructured healthcare data which is consumer oriented

Another object of the present invention is to provide a method and a system for securely sharing and analyzing these unstructured healthcare data, which can securely store the data in public server by creating secure view for the owner and if required by the owner, share the view as whole or in part with other healthcare entities. Secure view can be expanded or reduced dynamically. This will reduce cost for an individual where he does not have to visit doctor until and unless it is needed to be present in physical without compromising his healthcare data to 3^{rd} party who is not allowed to view the data. Daily conditions can be tracked using picture, video and text etc. to be shared with doctor(s), which will help doctors to see the effect of the medication provided. Doctor will be able to look at the shared heath care data even if the individual is not present physically which means no appointment is needed in regular hours leading to doctor spending time on those individual which needs physical attention

Yet another object of the present invention is to provide a method and a system for securely sharing and analyzing these unstructured healthcare data, which enables extraction of feature from data on user's device as per user consent before encrypting using user's and shared key as defined in PKI infrastructure and uploading the extracted feature in separate database without exposing the contextual data and identity of an individual's health data.

One more object of the present invention is to provide a method and a system for securely sharing and analyzing these unstructured healthcare data, in which healthcare entities or individual can perform the analysis of health data of an individual, using the training set based on extracted features stored in a reference database, on the user's device who has access to user's healthcare data.

Further object of the present invention is to provide a method and a system for securely sharing and analyzing these unstructured healthcare data, which fetches contextual customized or desired information from different sources as per health condition of an individual, determined by the features from user's healthcare data, without exposing user's identity to external sources.

Further one object of the present invention is to provide a method and a system for securely sharing and analyzing these unstructured healthcare data, which enables healthcare entities to consume the trends and information store in reference database so that they can provides healthcare services at low cost by taking informed decision such as producing the medicine as per the demand at particular location or use this data as a second opinion to provide effective medical advice so on and so forth but not restricted to.

### SUMMARY OF THE INVENTION

According to the present invention there is provided a method for securely sharing and analyzing the unstructured healthcare data of patients. The method comprising steps of collecting healthcare data, encrypting the healthcare data, uploading the encrypted healthcare data, fetching encrypted healthcare data, providing selective access to the healthcare data, extending the secure view to other users, reduce the secure view to other users as per the user scope and analyzing the patient's healthcare data. The healthcare data is collected, which is generated by providers and uploading the healthcare date to a device and to an interface. Further, features extracted are on the device and storing on a first server through the interface. The healthcare data is encrypted and uploaded in the interface by using a public key. The encrypted healthcare data is uploaded to a second server. Further encrypted healthcare data is fetch on the device from the second storage and decrypting the healthcare data on the first, second or third device before using the data. Selective access is provided to the healthcare data in the second server through the interface in a secure virtual view without transferring the actual healthcare data and by sharing the shared key which is encrypted using receiver public key and uploading the encrypted shared key in receiver virtual view. The secure view is extended to other users as per the user scope, who wants to share. The secure view is reduced to other users as per the user scope, who wants to share. At last the patient's healthcare data is analysed with respect to extracted features stored on the first server for generating trends and by building/executing query against external healthcare data source.

According to another aspect of the present invention there is provided a system for securely sharing and analyzing the unstructured healthcare data of patients. The system has a device, a feature extracting engine, an encrypting engine, a fetching engine and an analyzing engine. The device is used for uploading the healthcare data to an interface operated through a first server and a second server. The feature extracting engine is configured in the interface for extracting features from the healthcare data. The encrypting engine is configured in the interface for encrypting the healthcare data, which is then uploaded in the second servers. The fetching engine is provided for searching the healthcare data and a decrypting engine to decrypting the data for making the healthcare data selectivity available to a device. The analyzing engine is configured on the first server analyses the extracted features, thereby generating trends.

### BRIEF DESCRIPTION OF THE FIGURES

FIG. 1 shows a flow chart of the method 100 in accordance with the present invention;

FIG. 2 shows an exemplary uploading window of an interface in accordance with the present invention;

FIG. 3 shows an exemplary login window of an interface in accordance with the present invention;

FIGS. 4 to 7 shows an exemplary method for secure virtual views in accordance with the present invention.

FIGS. 8 and 9 show exemplary shared views provided by a user, and

FIG. 10 shows a first server having sample extracted feature stored in plain text without user context and second server which has user encrypted data with user context.

### DETAIL DESCRIPTION OF THE INVENTION

An embodiment of this invention, illustrating its features, will now be described in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The disclosed embodiments are merely exemplary of the invention, which may be embodied in various forms.

The present invention provides a method and a system for securely sharing and analyzing these unstructured healthcare data in consumer owned system and also overcome the drawbacks inherent in the present EHR systems. The method and the system can securely store the data centrally in cloud irrespective of entities which generate healthcare data and share the data via secure virtual view with other entities. Further, the method and the system enable consumer to analysis heath data based on training set created from the healthcare without exposing the context and identity for the individual's health data. The method and the system to create a training data set which is extracted features from health data and stored in reference database. Further, the method and the system provide customized or desired information from different sources as per health condition of an individual without individual's identity. Also, the method and the system expose the context less healthcare data with well-defined interfaces. Moreover, the method and the system exposes data for taking proactive healthcare measures and proactively identifying the individual health issues that can be encountered in futures by using the reference database.

The advantages and features of the present invention will become better understood with reference to the following detailed description and claims taken in conjunction with the accompanying drawings, wherein like elements are identified with like symbols.

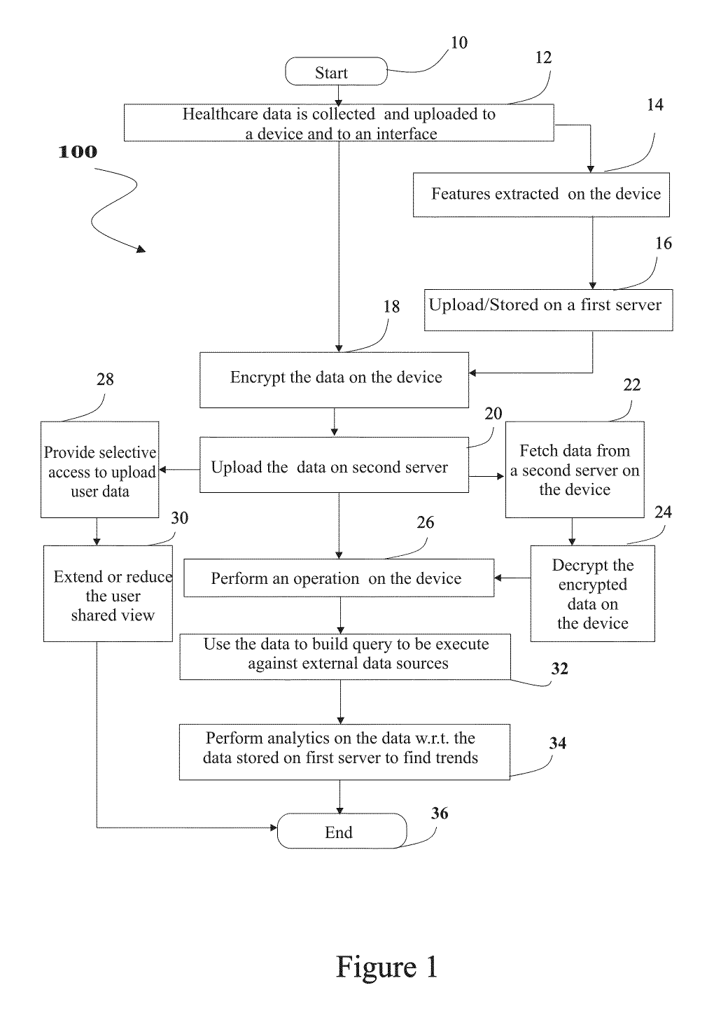

Referring now to FIG. 1, a flow chart of the method 100 in accordance with the present invention is illustrated. The method starts at step 10.

At step 12, healthcare data is collected and uploaded to a device, specifically, to a first device, which is the patient's device. Also, the healthcare data is uploaded to an interface simultaneously. The doctor's device is a second device and the diagnostic centres/healthcare provider device is a third device. It may be obvious to a person skilled in the art to use more devices. The healthcare data is generally generated by a user known as doctor, who diagnosis a patient or user known as the diagnostic facilities/centre, which conduct various test on the users and data generated by devices such as medical devices. This data is sent to the first device using the interfaces. User could be the patient for which the data is generated.

Further, historic healthcare data of the patient also can be feed to a second server after digitization of the patient's historic healthcare data. If the historic healthcare data is not in readable format, then it is first converted in to readable format and then up loaded. Also, a metric data relating to each of the patient is feed to respective unique ID. The metric data is the data relating to the present physical state of the patient. The metric data includes physical statistics like age, sex, height, weight, fat content etc., blood sugar, blood pressure, cholesterol level, any injuries, any healthcare data which can be tracked over time and the like. Further, different login ID is provided for doctors, diagnostic centres and patients.

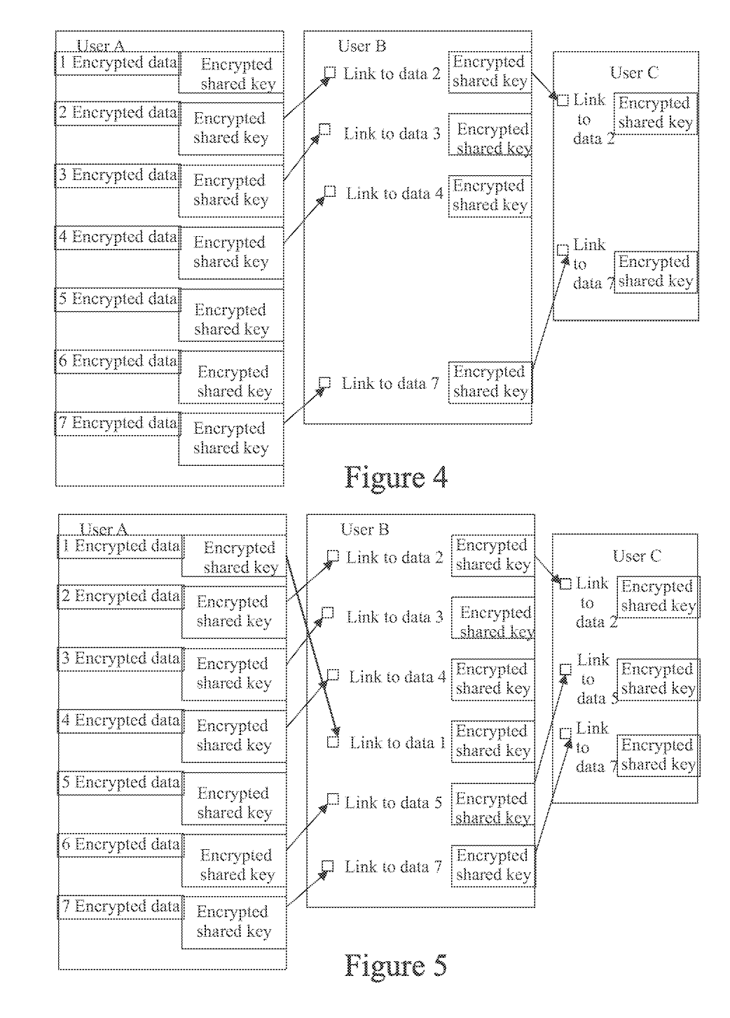

At step 14, the features are extracted from the healthcare data on the first device by using a feature extracting engine configured in the interface. After getting approval from the patient. Preference could control the approval for extracting the features as show by check box on FIG. 3. For extraction process, input is raw healthcare data, which is fed into the feature extracting engine and the output are substring in the text which represents the input text.

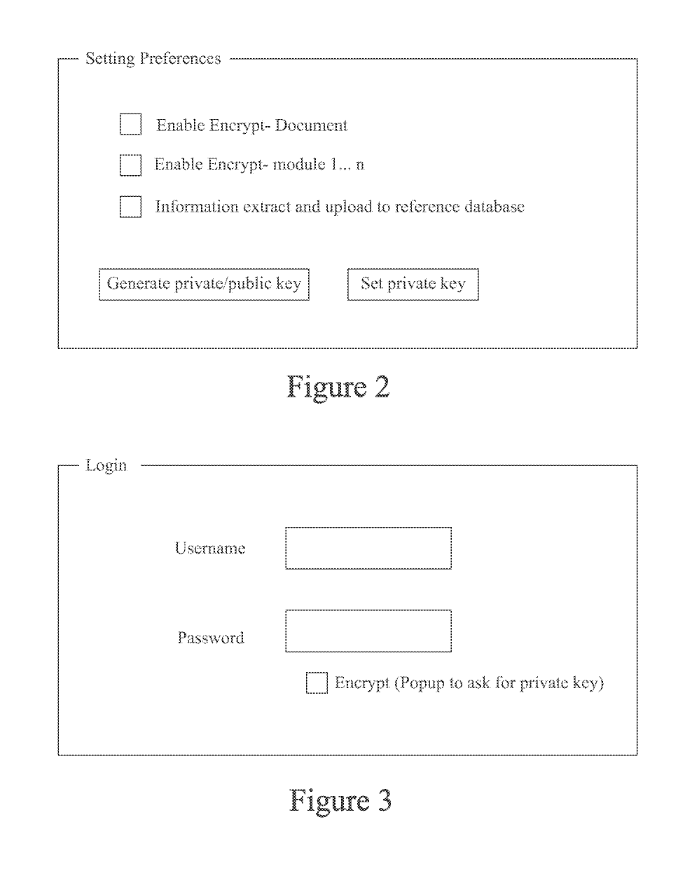

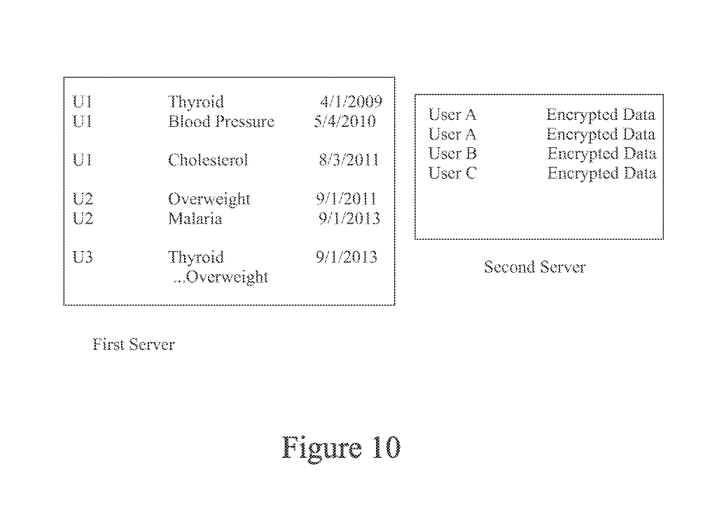

At step 16, the extracted features are stored separately on a first server without patient's identity details, thereby maintaining privacy of the user. When a user is clicking the upload button as shown on FIG. 2, in backend before uploading the encrypted data to second server, extracted feature are uploaded to first server transparently if the user has given the approval. FIG. 10 shows first server has sample extracted feature stored in plain text without user context.

At step 18, the data from step 12 and step 16 is encrypted on the first, second or third device. The process to encrypt data on either the first, second or third device uses a “shared key” to encrypt the data before uploading it in the second server using encrypting engine configured in the interface. The shared key is encrypted using the “public key” of the user against whom the encrypted data will be stored and encrypted shared key is also uploaded on second server in space designated for user. FIG. 10 also shows second server which has user encrypted data with user context. For encryption input is the data passed to encrypting engine and then an encrypted data is produced as an output.

This healthcare data is sent/uploaded to the second server from the first, second or third device using user ID against whom the data will be stored on second server at step 20. The user ID does not have authority/facility to modify the data. He can upload the modified copy but cannot modify the already uploaded data. The users can view/print/download the data. Further, the first, second and the third device can be a personal computer, a smart phone, a tablet phone and the like. The uploading process is initiated on either the first, second or third device by clicking the upload button as shown in FIG. 2.

At step 22, the encrypted heath care data is fetch on the first, second or third device from the second server to perform some actions on the first, second and the third device by clicking on the file link as shown on FIG. 2. Specifically, the fetching engine is used for fetching the above referred healthcare data.

At step 24 the data on the first, second or third device is decrypted before using the data; Decryption is done first by downloading and decrypting the shared key with the private key of an user set at the time login as shown in FIG. 3 or by providing the private key path in user preferences of logged in user as shown in FIG. 2 and then using plain text shared key to decrypt the actual data. The private key is stored on user local device or on server after encrypting. This plain text private key is never transmitted to server and always kept in user session on first, second or third device.

At step 26, the plain text data which is on the user device, various operation such as print/save but not limited to, can be performed by user. This step can be performed after step 20 in case the user is working on current plain text data available on the first, second or third device.

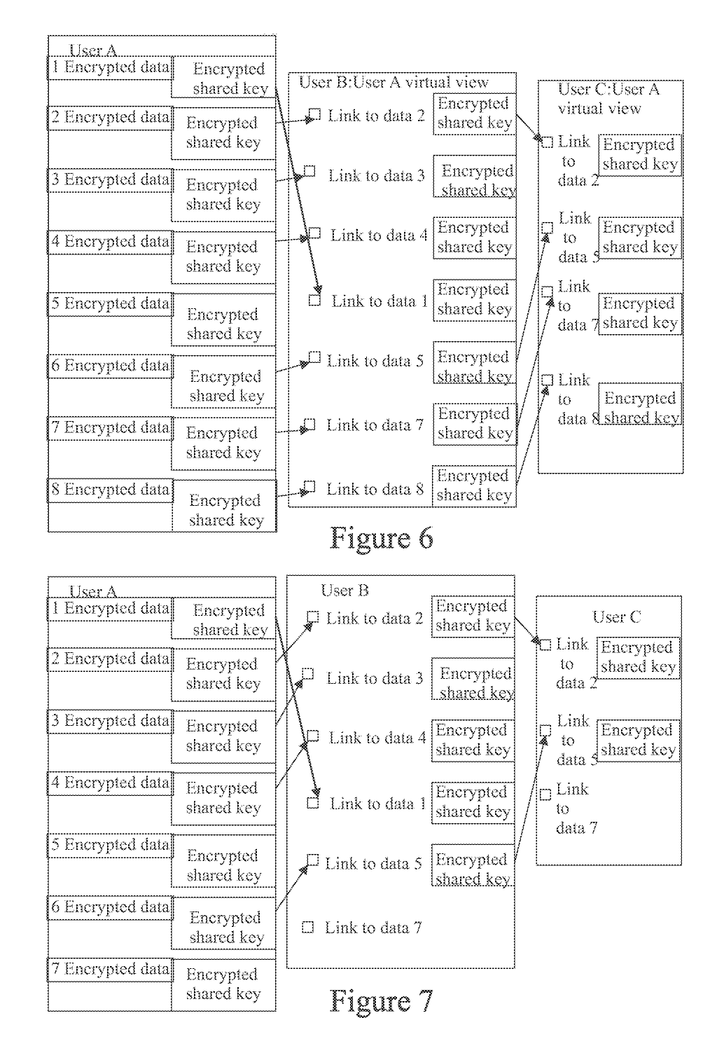

At step 28, this encrypted data which is uploaded at step 20, can be shared with other different type of user(s) present in the system. While sharing, the user can decide and select the portions or section of the report that can be viewed by another user. The user allows another user to have access to his data via a virtual secure view of an actual physical data stored on the second server. Sharing is performed by selecting the user, then clicking the set of file and using “Share” construct. This allow user to share the files and underneath the system, 1) Download the encrypted “share key” associated with the data 2) Decrypt them using owner private key, 3) Encrypt the shared key with the public key of the user with whom data will be shared, 4) Upload the “encrypted shared key” and the link of the encrypted file in the space designated to the user with whom the data is shared. Public key of respective user is stored on the second server and private key for user is stored on respective (first, second and thirds) device or stored on second server in encrypted form. Public and private key is generated at the time of user registration or later on user demand on either first, second or third device. Private Key is loaded on user session and kept in process running on the first, second or third device and is never sent across the wire. As shown in FIG. 4 the user “A” is a real owner of physical view and the selected data is shared with the user B, and which in turn shared selected data with the user C. The physical data is in user “A”'s view and the link is shared with the shared key which is encrypted with the user public key with which data will be received.

At step 30, the data view which is initial shared as described in step 28, can be extend (shown in FIG. 5) by sharing the already available data in physical view with the already available linked view or add new data in physical view and share with the existing virtual view.

Further new data can be added in the shared virtual view shown in FIG. 6. In FIG. 6, data (data 8) is added by user C in shared view of used ‘A’ hence the actual data is updated in physical secure view of user ‘A’ and link is added in the linked provider virtual secure views linked from physical view to virtual view of user A, for user C.

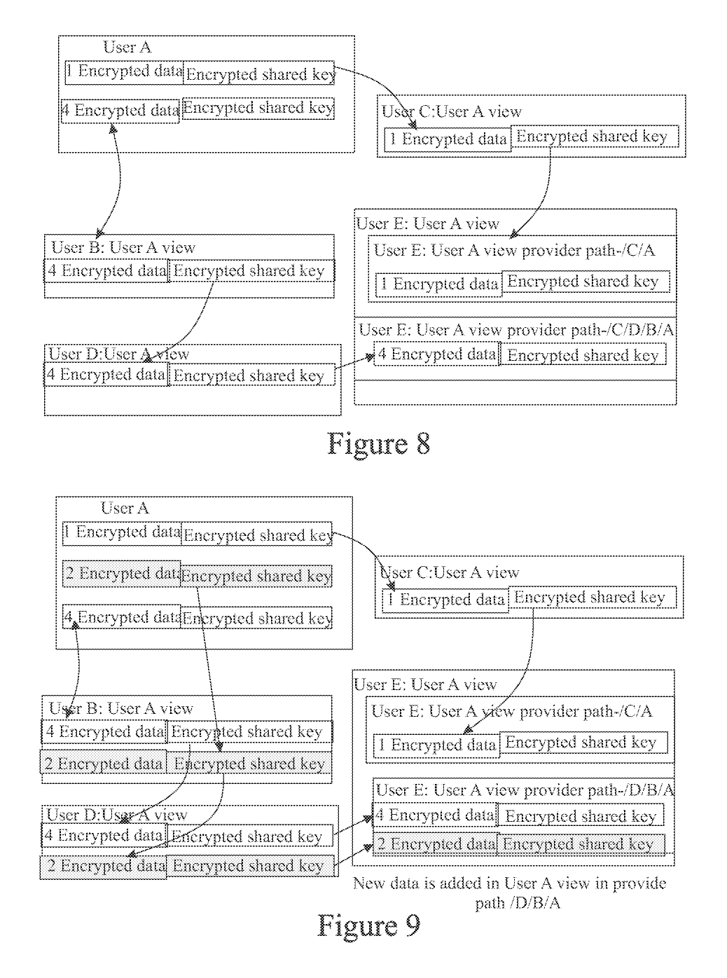

In FIG. 8, there could be multiple shared view of user ‘A’ as seen by user ‘E’ depending upon the provider linked views path, in this case while adding the data for user ‘A’, user ‘E’ may select provider linked view path, which may be used to update the physical view. In this case user has selected/D/B/A path hence the provider link virtual view D and B is also update as shown in FIG. 9. Secure view can be extended to the scope of the user who owns the view.

Secure view can be reduced by removing the data from the view shown in FIG. 7. This virtual view can be reduced by the user who owns the view. If the data is unshared by a user then the data is unshared from all the forwarded linked virtual secure views. As shown in FIG. 7, data has been deleted form physical secure view of the user “A” hence data reference is shown to be removed from all the forward linked virtual secure view.

At step 32, the data which is downloaded from second server and decrypted as done in step 24, is used to build the query which will be executed against the third party sources such as tweeter, maps or web to get more in context data for a user. This data could be medicines, Jogger Park or hospital or doctor's locations but not limited to depending upon the current location or home location.

At step 34, the extracted features from step 14 are used for finding the trends and these trends are generated by using an analyzing engine on first server through the interface for determining the user behaviour under question. The analyzing engine is software operating on the first server. This analysis is an input to the administrative authorities, doctors etc., to proactively understand the health behaviour and take actions. As shown in FIG. 2, sample data is converted in to metric form. These analysis results can be view on computer screen or on mobile screen. Also, these analysis results can be made available on social platforms without the user context.

The use of the analytic method may be different for different end consumers. For patients, it may enable them to find the trends in context of the data. Mine in-context data related to the medical symptom shown by trends from web sources. The context data could be the tips/causes of the trends, may be the relevant health related product information.

Further, patients can directly share medical history with the doctors and doctor can use the data from the medical history and use reference DB to find the cause and effect of the behaviour. The doctors can look at the history data and data available in reference DB to make its own informed decisions. The data analysis using machine learning which will take the input as the medical data (historical data/current health metric) of an individual and do the analysis with respect to the data available in the interfaces. The outcome is the relevant set of cases already available for study to be presented to doctor for further study of the case under considerations. Mining techniques such as clustering of the data, finding sequence of events as per the characteristics of the medical conditions using machine learning techniques will help doctors to organize and manage their patients' health

In case of enterprise/diagnostic centres, the data owner is an organization and the privacy is handled at organization level. All “Data” is seen by an authorize user and there is an encryption using the server certificates. When the new case comes, analyse the history or current health data in context of already available data collected/stored/extracted from the health record of already treated or under treatment of other patients under same entity or different entities which means collaboration of different entities to make the decision more precise, fast and diagnose conditions in earlier stages which will be occurring in near future. Text analysis based on entities extraction from text and then finds the relation between the extracted entities. The analysis is done on the healthcare data of plurality of patients for finding trends in particular location and the analysis is done on the healthcare data of a single patient for predictive diagnoses.

At step 36, the method 100 ends.

In an alternate embodiment, the present invention also includes a system for securely sharing and analyzing the unstructured healthcare data of patients. For the sake of brevity and as the elements in the system are already explained in details, here the system is explained in brief. The system includes a device, a first server, a second server, a feature extracting engine, an encrypting engine, a fetching engine and an analyzing engine. The device is used for uploading the healthcare data to an interface operated through a first server and a second server. The feature extracting engine is configured in the interface for extracting features from the healthcare data. The encrypting engine is configured in the interface for encrypting the healthcare data, which is then uploaded in the second servers. The fetching engine is provided for searching the healthcare data and a decrypting engine to decrypting the data for making the healthcare data selectivity available to a device. The analyzing engine configured on the first server analyses the extracted features, thereby generating trends from the healthcare data of plurality of patients.

### Working Example

Suppose a “user” had “thyroid” issue and then later after one year he was diagnosed for “cholesterol” and then after 2 year he was diagnosed for “blood pressure”.

There is a relationship created and time factor will be considered

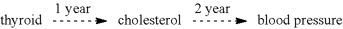

By creating this training set by mining these kinds of relationships between the health conditions, a new individual health condition can be predicted.

If the user/patient health is detected with some analogy then system can warn them in advance than about their health condition and provide some suggestions.

### Example

If the user has X symptom and Y symptom and if “another user” has Y symptom and then Z symptom the inference from this can be deducted for further analysis by doctor for an “user” which has X symptom that he can show symptom Z in near future.

In the method 100 of the present system, patient will have only read access to data which is uploaded by doctors and “diagnostic labs”. Patient will be able to see the trends, which will be inferred by his diagnostic centre reports. Based on these reports, the patient will see trends, current health situation and upcoming health impact and may be durations. The patients are the owner of his health information. The patient can share with the specific doctors. The doctor will have the read access to information uploaded by patient and can share further with other healthcare entities. Patient can selectively authorized doctor to have access to health data. Doctor can be the provider to the healthcare data for a patient. In this scenario doctor is the owner of the data in patient view and have the authority to provide the access of the data in patient view.

The method 100 of the present invention enables the patient to tracks his health irrespective of the location he was diagnosed and across different time frame he was diagnosed. Further, the method 100 enables the patient to gets personalized health information co-related with his own health anomaly. Further, interfaces can be used for personalized news/tips/comments mined from various sources. The patient is also provided with a digital vault to store the documents on this ID on the second server. Further, the doctors are able to look at comprehensive health view of a patent by looking at doctor provided prescription or the health report by using the interfaces. The interfaces can be used by doctor's collaboration interfaces where they can comment on particular trend which is shared on the interfaces. Doctors from anywhere around the global can refer to for second opinion using the interfaces or for second opinion from specific doctors or ask in open forms. These interfaces can also be used by insurance companies as a consumer derives the insurance policies for specific trends or personalized policy as per individual health history. At last Pharmaceutical companies will find the single interfaces to advertise their drugs, general tonic and medical apparatus. The interfaces where individual interacts with other individual or individual interact with doctor or doctor interact with another doctor for gathering the opinion.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

We claim:

1. A method for securely sharing and analyzing the unstructured healthcare data of patients, the method comprising steps of:
collecting healthcare data generated by providers and uploading the healthcare date to a device and to an interface;
extracting features on the device and storing the extracted features on a first server through the interface;
encrypting the healthcare data uploaded in the interface by using a public key;
uploading the encrypted healthcare data to a second server;
fetching encrypted healthcare data on the device from the second storage and decrypting the healthcare data on the first, second or third device before using the data;
providing selective access to the healthcare data in the second server through the interface in a secure virtual view without transferring the actual healthcare data and by sharing the shared key which is encrypted using receiver public key and uploading the encrypted shared key in receiver virtual view;
extending the secure view to other users as per the user scope, who want to share;
reducing the secure view to other users as per the user scope, who want to share; and
analyzing the patient's healthcare data with respect to extracted features stored on the first server for generating trends and by building/executing query against external healthcare data source.

2. The method as claimed in claim 1, wherein the feature selected from the healthcare data are extracted on the first device and uploaded on the first server through the interface.

3. The method as claimed in claim 1, wherein the stored healthcare data to the first server is computing for providing decision.

4. The method as claimed in claim 1, wherein the healthcare data is converted into readable format for extracting features.

5. The method as claimed in claim 1, wherein the healthcare data includes a metric data and a diagnostic data.

6. The method as claimed in claim 5, wherein the metric data includes physical statistics of the patient, age, sex, blood sugar, cholesterol level blood pressure and the like.

7. The method as claimed in claim 1, wherein the analysis of the healthcare data in the first server is done on the base of location, age, sex, current health conditions and life style of the patients.

8. The method as claimed in claim 1, wherein the selective or entire healthcare data is encrypted and saved in the second server.

9. The method as claimed in claim 1, wherein the encrypted healthcare data access is provided with zero or more selected doctor or with the diagnostic facilities or individual.

10. The method as claimed in claim 1, wherein the interfaces is a software infrastructure platform for accessing, communicating and processing the healthcare data therethrough enables secure communication between servers and the devices.

11. The method as claimed in claim 1, wherein the selective access to the healthcare data can be provided on request.

12. The method as claimed in claim 1, wherein the interface is cloud base software and hardware infrastructure.

13. The method as claimed in claim 11, wherein the first device is selected from a group consisting of a personal computer, a smart phone, a tablet phone and the like.

14. The method as claimed in claim 1, wherein the healthcare data on the second server is a secure view for an owner and it can be extended to other users which can have restricted scope then the one of the secure view owner has.

15. The method as claimed in claim 1, wherein the healthcare data in secure view for a user on the second server can be added by adding the healthcare data link from physical view and encrypting shared key for the healthcare data to be included in secure virtual view.

16. The method as claimed in claim 1, wherein the healthcare data in share secure view for an user on the second server can be added by adding the healthcare data in physical view and adding the link to all the provider link views.

17. The method as claimed in claim 1, wherein the healthcare data in secure view for a user on second server can be deleted by deleting the link and encrypted key from secure view and all the forward link to which the view has provided the healthcare data will also be deleted.

18. A system for securely sharing and analyzing the unstructured healthcare data of patients, the system comprising:
a device for uploading the healthcare data to an interface operated through a first server and a second server;
a feature extracting engine configured in the interface for extracting features from the healthcare data;
an encrypting engine configured in the interface for encrypting the healthcare data, which is then uploaded in the second servers;
a fetching engine for searching the healthcare data and a decrypting engine to decrypting the data for making the healthcare data selectivity available to a device, and
an analyzing engine configured on the first server analyses the extracted features, thereby generating trends.
